(19) United States
(12) Patent Application Publication
(10) Pub. No.: US 2015/0113297 A1
(43) Pub. Date: Apr. 23, 2015

(54) KEYBOARD AND CONTROL SYSTEM FOR THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventor: QIAN LEI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/252,103

(22) Filed: Apr. 14, 2014

(30) Foreign Application Priority Data
Oct. 18, 2013 (CN) 2013104898508

(51) Int. Cl. G06F 1/26

(52) U.S. Cl. CPC G06F 1/266
USPC 713/310

(57) ABSTRACT

A keyboard with a host shutdown function includes a storage unit, a timer, and a processor. The storage unit stores a predefined length of time. The processor includes a power detection module and a time control module. The power detection module detects the keyboard being powered on. The time control module records the working time of the keyboard and to send a control signal to the host connected to the keyboard to shut the host down when the recorded duration time reaches the predefined length of time. A control system for the keyboard is also provided.

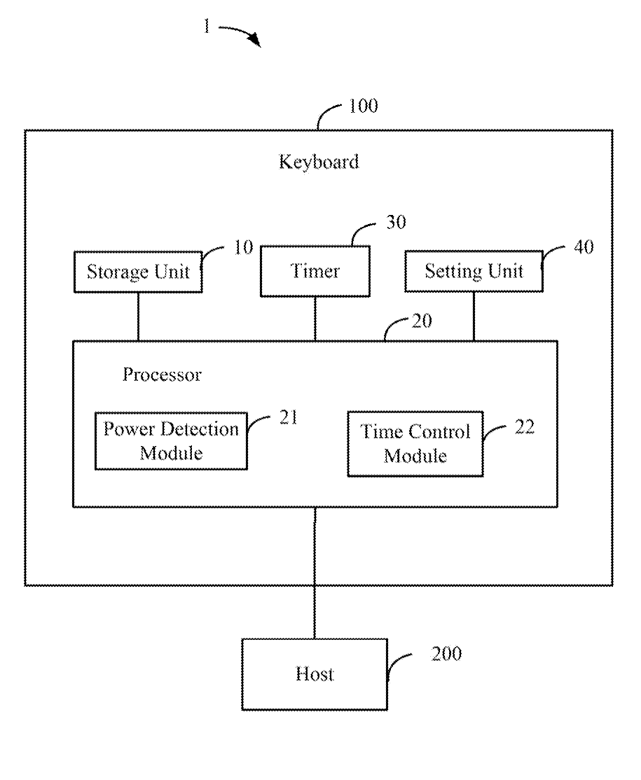

### FIELD

The present disclosure relates to keyboards and control systems, and particularly to a keyboard having a time control function and a control system governing the keyboard.

### BACKGROUND

Children today spend a lot of time on a computer. Parents may install various anti-addiction software on the computers to prevent their children becoming addicted to online games and internet surfing. However, software for cracking the anti-addiction software can be downloaded. Parents may not have enough time and effort to oversee their children at all times, and even if they do, such oversight can cause psychological harm and pressure to the children.

### BRIEF DESCRIPTION OF THE DRAWINGS

The components in the drawing are not necessarily drawn to scale, the emphasis instead being placed upon clearly illustrating the principles of the present disclosure.

The FIGURE is a block diagram of a control system for a keyboard with a time control function, in accordance with an exemplary embodiment.

### DETAILED DESCRIPTION

The FIGURE is an exemplary embodiment of a block diagram of a control system 1. The control system 1 can include a keyboard 100 and a host 200 connected to the keyboard 100. In the embodiment, the keyboard 100 records a duration of its own working status, and automatically controls the host 200 to shut down when the working duration arrives a predefined length of time, and thus calculated to prevent a user of the control system 1 from becoming addicted to online games and the internet.

The keyboard 100 includes a storage unit 10, a processor 20, and a timer 30. The storage unit 10 stores a predefined length of time predefined by the user, such as the parents.

The processor 20 includes a power detection module 21 and a time control module 22. The power detection module 21 detects the real-time status of the power supply of the keyboard 100. That is, the power detection module 21 detects whether the power to the keyboard 100 is on or off. The power to the keyboard being on indicates that the keyboard is working, that is. The time control module 22 controls the timer 30 to record the duration of the working time of the keyboard 100 after the keyboard 100 is powered on, and sends a control signal to the host 200 to shut the host 200 down when the recorded duration reaches a predefined length of time stored in the storage unit 10.

In at least one embodiment, when the power detection module 21 detects that the keyboard 100 is powered on, the time control module 22 controls the timer 30 to start. In the known art, generally, when the host 200 is powered on, the keyboard 100 connected with the host 200 receives power from the host 200. The power detection module 21 then detects that the keyboard 100 is powered on. The control signal sent from the time control module 22 simulates a shut down signal from a user in selecting a shut down option on the screen of the host 100. When the time control module 22 sends the shutdown control signal, the time control module 22 also controls the timer 30 to stop timing and clears the recorded time. Furthermore, after the host 200 is powered off, the power supplied by the host 200 to the keyboard 100 is discontinued and the keyboard 100 is powered off accordingly.

The host 200 automatically shuts down when the control signal sent from the time control module 22 is received. In at least one embodiment, the host 200 also stores all of the files currently open before being shut down.

The keyboard 100 also includes a setting unit 40 for providing a time setting interface. An authorized user such as a parent can set a predefined length of time on the time setting interface. The predefined length of time is stored in the storage unit 10. In the embodiment, the setting unit 40 is a touch screen installed on the keyboard 100. When a touch is applied on the setting unit 40, the processor 20 controls the setting unit 40 to display a dialog box for a password. After the password input by the user is verified, the setting unit 40 also displays a dialog box inviting the input of a time interval and stores the input time interval in the storage unit 10 as the predefined length of time. That is, the predefined length of time or an updated predefined length of time is created. In an alternative embodiment, the setting unit 40 includes a liquid crystal display and one or more physical rather than virtual buttons.

With such a configuration, the authorized user can set a predefined length of time via the setting unit 40 of the keyboard 100. When a user turns on the host 200, the keyboard 100 starts recording a working duration and controls the host 200 to shut down when the recorded time interval reaches the predefined length of time stored in the storage unit 10.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A keyboard comprising:
a storage unit storing a predefined length of time;
a timer; and
a processor comprising:
a power detection module, configured to detect a real-time status of a power supply of the keyboard; and
a time control module, configured to control the timer to record a duration of the working time of the keyboard after the keyboard is powered on, and to send a control signal to a host connected to the keyboard to shut the host down when the recorded duration reaches the predefined length of time.

2. The keyboard of claim 1, further comprising a setting unit providing a time setting interface for setting the predefined length of time.

3. The keyboard of claim 2, wherein the setting unit comprises a touch screen.

4. The keyboard of claim 2, wherein the setting unit comprises a liquid crystal display and one or more physical buttons.

5. The keyboard of claim 1, wherein the time control module also controls the timer to stop timing and clears the recorded time when a length of the recorded time reaches the predefined length of time.

6. The keyboard of claim 1, wherein the control signal simulates a shut down signal from a user in selecting a shut down option on a screen of the host.

7. A control system comprising:
a host; and
a keyboard connected to the host, the keyboard comprising:
a storage unit storing a predefined length of time;
a timer; and
a processor comprising:
a power detection module, configured to detect a real-time status of a power supply of the keyboard; and
a time control module, configured to control the timer to record a duration of the working time of the keyboard after the keyboard is powered on, and to send a control signal to the host connected to the keyboard to shut the host down when the recorded duration reaches the predefined length of time.

8. The control system of claim 7, wherein the keyboard further comprises a setting unit providing a time setting interface for setting the predefined length of time.

9. The control system of claim 8, wherein the setting unit is a touch screen.

10. The control system of claim 8, wherein the setting unit comprises a liquid crystal display and one or more physical buttons.

11. The control system of claim 7, wherein the time control module also controls the timer to stop timing and clears the recorded time when a length of the recorded time reaches the predefined length of time.

12. The control system of claim 7, wherein the host stores all of the files currently open before being shut down.

13. The control system of claim 7, wherein the control signal simulates a shut down signal from a user in selecting a shut down option on a screen of the host.
